(19) United States
(12) Patent Application Publication
(10) Pub. No.: US 2026/0213062 A1
(43) Pub. Date: Jul. 23, 2026

(54) COIL COMPONENT

(71) Applicant: TDK CORPORATION, Tokyo (JP)

(72) Inventors: Tomonaga NISHIKAWA, Tokyo (JP); Akira MOTOHASHI, Tokyo (JP); Yuuichi KAWAGUCHI, Tokyo (JP); Daiki TSUJI, Tokyo (JP); Jumpei OUCHI, Tokyo (JP)

(73) Assignee: TDK CORPORATION, Tokyo (JP)

(21) Appl. No.: 19/451,543

(22) Filed: Jan. 16, 2026

(30) Foreign Application Priority Data
Jan. 23, 2025 (JP) 2025-009549

(51) Int. Cl. H01F 27/28; H01F 27/29

(52) U.S. Cl. CPC H01F 27/2804; H01F 27/292; H01F 2027/2809

(57) ABSTRACT

Disclosed herein is a coil component that includes: an element body having a mounting surface; a coil part embedded in the element body and having one end and other end exposed on the mounting surface; an insulating coating film covering the mounting surface, the insulating coating film having a first opening through which the one end of the coil part is exposed and a second opening through which the other end of the coil part is exposed; a first terminal electrode provided in the first opening and contacting the one end of the coil part without overlapping the coating film; and a second terminal electrode provided in the second opening and contacting the other end of the coil part without overlapping the coating film.

### CROSS-REFERENCE TO RELATED APPLICATION

This application claims the benefit of Japanese Patent Application No. 2025-009549, filed on January 23, 2025, the entire disclosure of which is incorporated by reference herein.

### BACKGROUND OF THE ART

### Field of the Art

The present disclosure relates to a coil component and, more particularly, to a coil component having a structure in which the surface of an element body is covered with a coating film.

### Description of Related Art

JP 2024-085105A discloses a coil component having a structure in which the surface of an element body is covered with a coating film. The use of such a coating film enhances product reliability.

However, covering the surface of the element body with the coating film disadvantageously increases the product size because of the thickness of the film.

### SUMMARY

A coil component according to an aspect of the present disclosure includes: an element body having a mounting surface; a coil part embedded in the element body and having one end and the other end exposed on the mounting surface; an insulating coating film covering the mounting surface and having a first opening through which the one end of the coil part is exposed and a second opening through which the other end of the coil part is exposed; a first terminal electrode provided in the first opening and contacting the one end of the coil part without overlapping the coating film; and a second terminal electrode provided in the second opening and contacting the other end of the coil part without overlapping the coating film.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic perspective view illustrating the external appearance of a coil component 100 according to an embodiment of the technology described herein;

FIG. 2 is a schematic perspective view illustrating the coil component 100 from which the terminal electrodes 121, 122 and the coating film 140 have been removed;

FIG. 3 is a schematic cross-sectional view for explaining the structure of the conductor layer L1 in the coil component 100;

FIG. 4 is a schematic cross-sectional view for explaining the structure of the conductor layer L2 in the coil component 100;

FIG. 5 is a schematic cross-sectional view for explaining the structure of the conductor layer L3 in the coil component 100;

FIG. 6 is a schematic cross-sectional view for explaining the structure of the conductor layer L4 in the coil component 100;

FIG. 7 is a schematic cross-sectional view for explaining the structure of the conductor layer L5 in the coil component 100;

FIG. 8 is a schematic cross-sectional view for explaining the structure of the conductor layer L6 in the coil component 100;

FIG. 9 is a schematic cross-sectional view for explaining a structure according to a first modification;

FIG. 10 is a schematic cross-sectional view for explaining a structure according to a second modification;

FIG. 11 is a schematic cross-sectional view for explaining a structure according to a third modification;

FIG. 12 is a schematic cross-sectional view for explaining a structure according to a fourth modification; and

FIG. 13 is a schematic cross-sectional view for explaining a structure according to a fifth modification.

### DETAILED DESCRIPTION OF THE EMBODIMENTS

The present disclosure describes a technology for reducing the height of a coil component having a structure in which the surface of an element body is covered with a coating film when the coil component is mounted in a circuit board.

Some embodiments of the present disclosure will be explained below in detail with reference to the accompanying drawings.

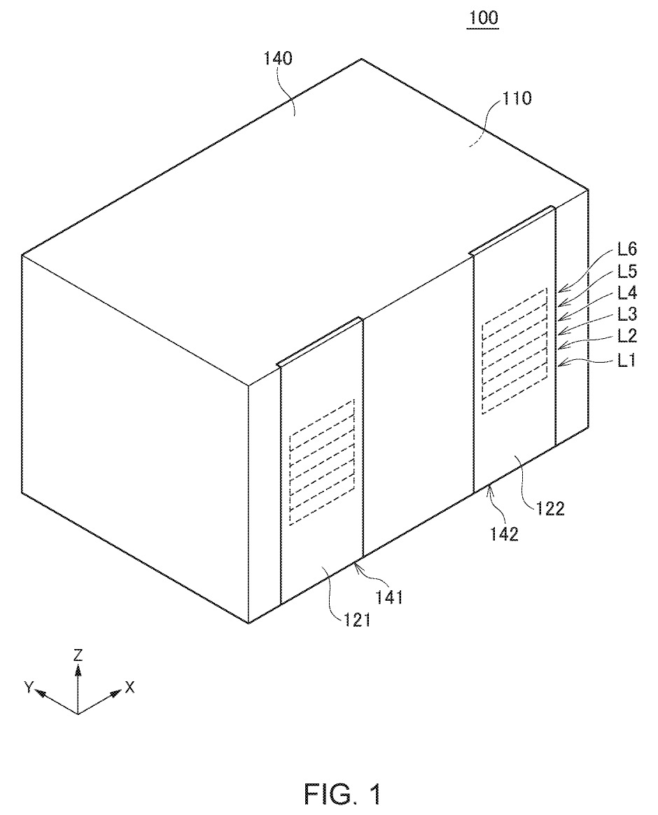

FIG. 1 is a schematic perspective view illustrating the external appearance of a coil component 100 according to an embodiment of the technology described herein.

As illustrated in FIG. 1, the coil component 100 according to the present embodiment includes an element body 110, an insulating coating film 140 covering the surface of the element body 110, a terminal electrode 121 provided in an opening 141 formed in the coating film 140, and a terminal electrode 122 provided in an opening 142 formed in the coating film 140. As described later, a coil part including conductor layers L1 to L6 are embedded in the element body 110, with one end of the coil part connected to the terminal electrode 121 and the other end connected to the terminal electrode 122. The element body 110 may be made of a composite magnetic material obtained by binding, with binder resin, magnetic filler particles formed of a high-permeability material such as ferrite or permalloy.

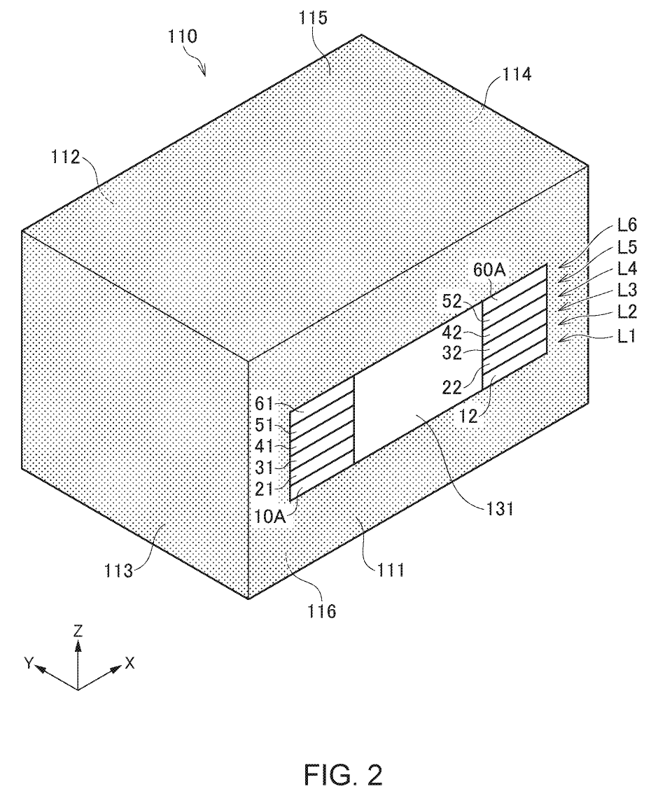

FIG. 2 is a schematic perspective view illustrating the coil component 100 from which the terminal electrodes 121, 122 and the coating film 140 have been removed.

As illustrated in FIG. 2, the element body 110 has a mounting surface 111 and an upper surface 112, which together define the XZ plane and are located on mutually opposite sides; side surfaces 113 and 114, which define the YZ plane and are located on mutually opposite sides; and side surfaces 115 and 116, which define the XY plane and are located on mutually opposite sides. Accordingly, these three sets (111 and 112, 113 and 114, 115 and 116) of surfaces are orthogonal to one another.

An outer peripheral end 10A of a coil pattern located in the conductor layer L1, and terminal patterns 21, 31, 41, 51, and 61 respectively located in the conductor layers L2 to L6, are exposed on the mounting surface 111 of the element body 110 and are arranged in the Z-direction on the mounting surface 111. The outer peripheral end 10A of the coil pattern and the terminal patterns 21, 31, 41, 51, and 61 are exposed through the opening 141 of the coating film 140 and come into contact with the terminal electrode 121 formed in the opening 141. Further, terminal patterns 12, 22, 32, 42, and 52 respectively located in the conductor layers L1 to L5 and an outer peripheral end 60A of a coil pattern located in the conductor layer L6 are exposed on the mounting surface 111 of the element body 110 and are arranged in the Z-direction on the mounting surface 111. The terminal patterns 12, 22, 32, 42, and 52 and the outer peripheral end 60A of the coil pattern are exposed through the opening 142 of the coating film 140 and come into contact with the terminal electrode 122 formed in the opening 142.

Through the openings 141 and 142, not only portions of the conductor layers L1 to L6 but also a portion of the mounting surface 111 of the element body 110 may be exposed. Further, an exposed part 131 of an insulating resin may be exposed on a region between the group consisting of the outer peripheral end 10A of the coil pattern and the terminal patterns 21, 31, 41, 51, and 61, and the group consisting of the terminal patterns 12, 22, 32, 42, and 52 and the outer peripheral end 60A of the coil pattern. The exposed part 131 may be partially exposed through the opening 141 or the opening 142.

The surface of the element body 110 configured as described above may be fully covered with the coating film 140, except for the openings 141 and 142. More specifically, the upper surface 112 and the side surfaces 113 to 116 may be fully covered with the coating film 140, and the mounting surface 111 may be fully covered with the coating film 140, except for the openings 141 and 142. The coating film 140 serves to protect the element body 110 and to prevent detachment of the filler particles contained in the element body 110. Even when the element body 110 has conductivity, a short-circuit failure after mounting on a circuit board can be prevented by covering the surface of the element body 110 with the coating film 140.

Examples of the material for the coating film 140 may include polyamideimide resin, epoxy resin, and a mixture of inorganic coating agent (e.g., silica) and acrylic resin. The coating film 140 may be formed on the entire surface of the element body 110 using a spray coating method, a dip coating method, a sol-gel method, or the like. After that, the openings 141 and 142 may be formed by removing, by laser irradiation, portions of the thus-formed coating film 140 covering the mounting surface 111.

As described above, the terminal electrode 121 is provided in the opening 141 of the coating film 140, and the terminal electrode 122 is provided in the opening 142 of the coating film 140. The formation positions of the terminal electrodes 121 and 122 are restricted to the openings 141 and 142, respectively, and the terminal electrodes 121 and 122 do not have portions overlapping the coating film 140. That is, the terminal electrodes 121 and 122 do not have portions that overlap the mounting surface 111 in the Y-direction through the coating film 140. Thus, compared with a case where the terminal electrodes 121 and 122 are formed so as to overlap the coating film 140, product height in the Y-direction can be reduced when the coil component 100 is mounted on a circuit board. Although the terminal electrodes 121 and 122 may not contact the coating film 140, they may contact the inner walls of the openings 141 and 142.

The terminal electrodes 121 and 122 may each have a thickness smaller than that of the coating film 140. That is, the terminal electrodes 121 and 122 do not protrude from the openings 141 and 142, respectively, thereby further reducing the height of the coil component 100 when it is mounted on a circuit board. In order to make the thicknesses of the terminal electrodes 121 and 122 smaller than that of the coating film 140, the terminal electrodes 121 and 122 may be formed by electroless plating.

The coil component 100 according to the present embodiment has a configuration in which the six conductor layers L1 to L6 constituting the coil part are embedded in the element body 110. The conductor layers L1 to L6 are stacked in the Z-direction, which is parallel to the mounting surface 111.

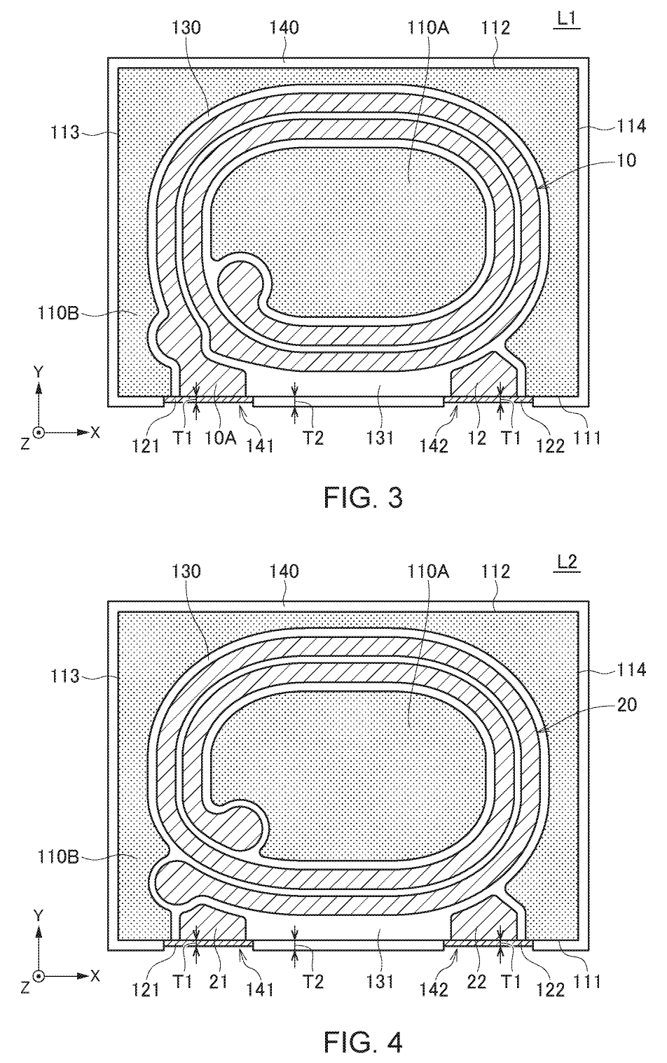

FIGS. 3 to 8 are schematic cross-sectional views for respectively explaining the structures of the conductor layers L1 to L6.

The conductor layer L1 is located at the end portion in the negative Z-direction and is formed first during manufacturing. In the example illustrated in FIG. 3, the conductor layer L1 includes a coil pattern 10 wound in about two turns and the terminal pattern 12 provided separately from the coil pattern 10 in the same plane. The outer peripheral end 10A of the coil pattern 10 and the terminal pattern 12 are exposed on the mounting surface 11 of the element body 110. An insulating resin 130 is provided between the conductor layer L1 and the element body 110, whereby contact therebetween is prevented. The insulating resin 130 may be made of a material obtained by binding, with a binder resin, inorganic filler particles formed of an insulating material such as silica.

The conductor layer L2 is the second conductor layer counted from the end portion in the negative Z-direction and is formed subsequent to the conductor layer L1 with the insulating resin 130 interposed therebetween during manufacturing. In the example illustrated in FIG. 4, the conductor layer L2 includes a coil pattern 20 wound in about two turns and the terminal patterns 21 and 22, which are provided separately from the coil pattern 20 in the same plane. The inner peripheral end of the coil pattern 20 is connected to the inner peripheral end of the coil pattern 10 located in the conductor layer L1 through a via formed in the insulating resin 130. The terminal patterns 21 and 22 are respectively connected to the outer peripheral end 10A of the coil pattern 10 and the terminal pattern 12 through vias formed in the insulating resin 130. The terminal patterns 21 and 22 are exposed on the mounting surface 111 of the element body 110. The insulating resin 130 is provided between the conductor layer L2 and the element body 110 and between the conductor layers L1 and L2, whereby the conductor layers L1 and L2 are separated from each other, and contact between the conductor layer L2 and the element body 110 is prevented.

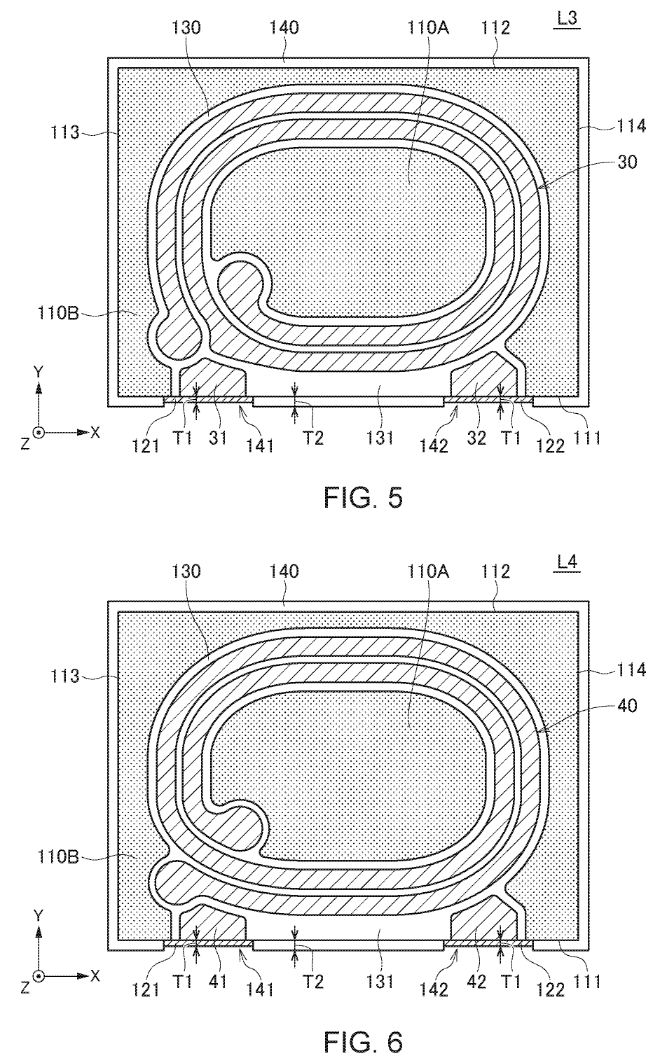

The conductor layer L3 is the third conductor layer counted from the end portion in the negative Z-direction and is formed subsequent to the conductor layer L2 with the insulating resin 130 interposed therebetween during manufacturing. In the example illustrated in FIG. 5, the conductor layer L3 includes a coil pattern 30 wound in about two turns and the terminal patterns 31 and 32, which are provided separately from the coil pattern 30 in the same plane. The outer peripheral end of the coil pattern 30 is connected to the outer peripheral end of the coil pattern 20 located in the conductor layer L2 through a via formed in the insulating resin 130. The terminal patterns 31 and 32 are respectively connected to the terminal patterns 21 and 22 in the conductor layer L2 through vias formed in the insulating resin 130. The terminal patterns 31 and 32 are exposed on the mounting surface 111 of the element body 110. The insulating resin 130 is provided between the conductor layer L3 and the element body 110 and between the conductor layers L2 and L3, whereby the conductor layers L2 and L3 are separated from each other, and contact between the conductor layer L3 and the element body 110 is prevented.

The conductor layer L4 is the fourth conductor layer counted from the end portion in the negative Z-direction and is formed subsequent to the conductor layer L3 with the insulating resin 130 interposed therebetween during manufacturing. In the example illustrated in FIG. 6, the conductor layer L4 includes a coil pattern 40 wound in about two turns and the terminal patterns 41 and 42, which are provided separately from the coil pattern 40 in the same plane. The inner peripheral end of the coil pattern 40 is connected to the inner peripheral end of the coil pattern 30 located in the conductor layer L3 through a via formed in the insulating resin 130. The terminal patterns 41 and 42 are respectively connected to the terminal patterns 31 and 32 in the conductor layer L3 through vias formed in the insulating resin 130. The terminal patterns 41 and 42 are exposed on the mounting surface 111 of the element body 110. The insulating resin 130 is provided between the conductor layer L4 and the element body 110 and between the conductor layers L3 and L4, whereby the conductor layers L3 and L4 are separated from each other, and contact between the conductor layer L4 and the element body 110 is prevented.

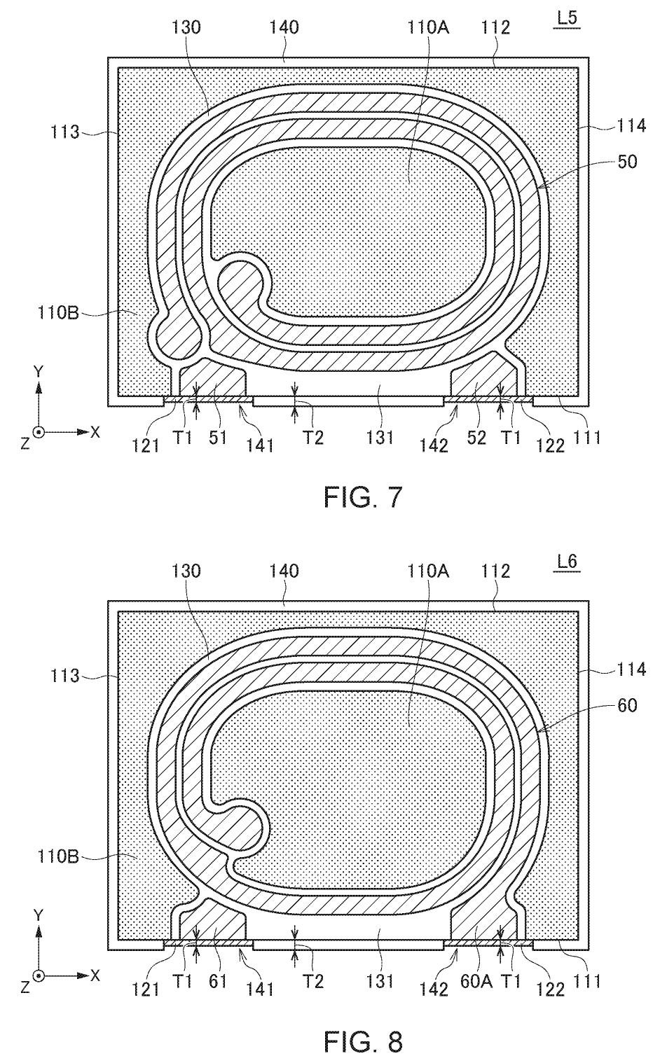

The conductor layer L5 is the fifth conductor layer counted from the end portion in the negative Z-direction and is formed subsequent to the conductor layer L4 with the insulating resin 130 interposed therebetween during manufacturing. In the example illustrated in FIG. 7, the conductor layer L5 includes a coil pattern 50 wound in about two turns and the terminal patterns 51 and 52, which are provided separately from the coil pattern 50 in the same plane. The outer peripheral end of the coil pattern 50 is connected to the outer peripheral end of the coil pattern 40 located in the conductor layer L4 through a via formed in the insulating resin 130. The terminal patterns 51 and 52 are respectively connected to the terminal patterns 41 and 42 in the conductor layer L4 through vias formed in the insulating resin 130. The terminal patterns 51 and 52 are exposed on the mounting surface 111 of the element body 110. The insulating resin 130 is provided between the conductor layer L5 and the element body 110 and between the conductor layers L4 and L5, whereby the conductor layers L4 and L5 are separated from each other, and contact between the conductor layer L5 and the element body 110 is prevented.

The conductor layer L6 is located at the end portion in the positive Z-direction and is formed subsequent to the conductor layer L5 with the insulating resin 130 interposed therebetween during manufacturing. In the example illustrated in FIG. 8, the conductor layer L6 includes a coil pattern 60 wound in about two turns and the terminal pattern 61, which is provided separately from the coil pattern 60 in the same plane. The inner peripheral end of the coil pattern 60 is connected to the inner peripheral end of the coil pattern 50 located in the conductor layer L5 through a via formed in the insulating resin 130. The terminal pattern 61 and the outer peripheral end 60A of the coil pattern 60 are respectively connected to the terminal patterns 51 and 52 in the conductor layer L5 through vias formed in the insulating resin 130. The terminal pattern 61 and the outer peripheral end 60A of the coil pattern 60 are exposed on the mounting surface 111 of the element body 110. The insulating resin 130 is provided between the conductor layer L6 and the element body 110 and between the conductor layers L5 and L6, whereby the conductor layers L5 and L6 are separated from each other, and contact between the conductor layer L6 and the element body 110 is prevented.

With the above configuration, the six coil patterns 10, 20, 30, 40, 50, and 60 are connected in series inside the element body 110 to constitute the coil part. In this coil part, the outer peripheral end 10A of the coil pattern 10 serves as one end and is connected to the terminal electrode 121, while the outer peripheral end 60A of the coil pattern 60 serves as the other end and is connected to the terminal electrode 122. For the coil patterns 20, 30, 40, and 50 located in the conductor layers L2 to L5, one end thereof is connected to the terminal electrode 121 through the coil pattern 10, while the other end thereof is connected to the terminal electrode 122 through the coil pattern 60.

As illustrated in FIGS. 3 to 8, a portion of the insulating resin 130 forms the exposed part 131 that is exposed on the mounting surface 111 of the element body 110. The insulating resin 130 may be partially exposed on the upper surface 112 and the side surfaces 113 and 134 of the element body 110. In the planes illustrated in FIGS. 3 to 8, the element body 110 is divided into two regions 110A and 110B. The region 110A is located inside a portion surrounded by the coil patterns 10, 20, 30, 40, 50, and 60. The region 110B is located outside the portion surrounded by the coil patterns 10, 20, 30, 40, 50, and 60, and constitute the mounting surface 111, upper surface 112, and side surfaces 113 and 114 of the element body 110. In the planes illustrated in FIGS. 3 to 8, the element body 110 is absent in the region between the group consisting of the outer peripheral end 10A of the coil pattern and the terminal patterns 21, 31, 41, 51, and 61, and the group consisting of the terminal patterns 12, 22, 32, 42, and 52 and the outer peripheral end 60A of the coil pattern. In this region, the exposed part 131 of the insulating resin 130 is present. As a result, the filler particles are unlikely to detach from this region.

In the example illustrated in FIGS. 3 to 8, the mounting surface 111 of the element body 110, the conductor layers L1 to L6 exposed on the mounting surface 111, and the exposed part 131 of the insulating resin 130 on the mounting surface 111 form substantially the same plane. The openings 141 and 142 are formed in the coating film 140 that covers the mounting surface 111, and the terminal electrodes 121 and 122 are respectively provided in the openings 141 and 142. In the example illustrated in FIGS. 3 to 8, a thickness T1 of the terminal electrodes 121 and 122 is smaller than a thickness T2 of the coating film 140 that covers the mounting surface 111, so that the terminal electrodes 121 and 122 do not protrude from the surface of the coating film 140 but are recessed. As a result, when the coil component 100 is mounted on a circuit board using solder or the like, the mounting height can be reduced.

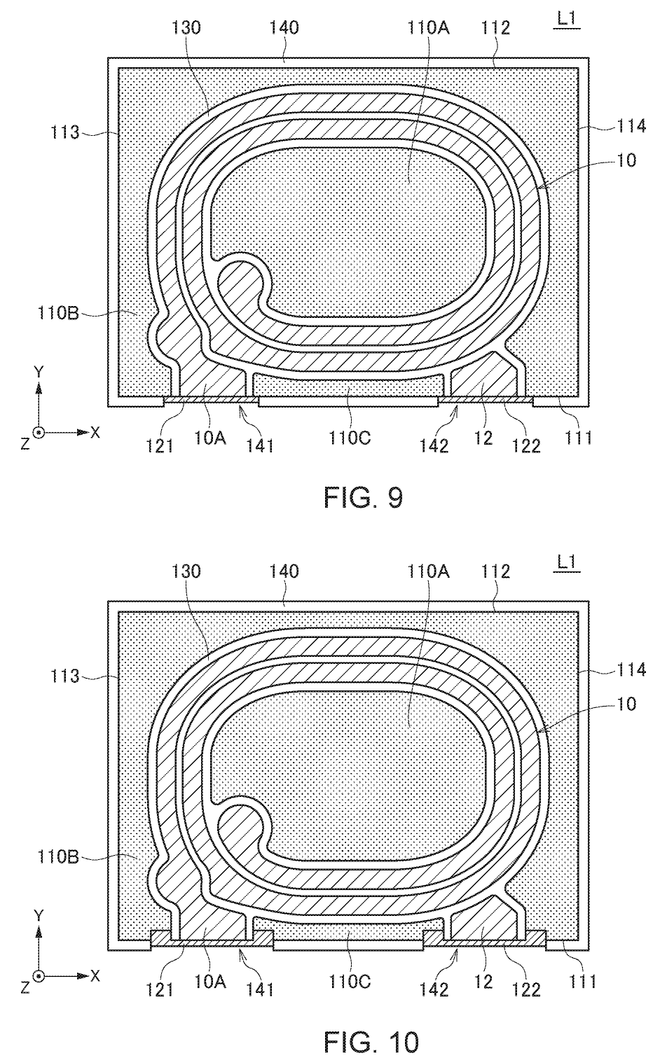

FIG. 9 is a schematic cross-sectional view for explaining a structure according to a first modification.

In the first modification illustrated in FIG. 9, a portion corresponding to the exposed part 131 of the insulating resin 130 is constituted by the element body 110. Although only the cross section in which the conductor layer L1 appears is illustrated in FIG. 9, the same applies to the cross sections in which the conductor layers L2 to L6 appear. As exemplified by the first modification, the portion corresponding to the exposed part 131 of the insulating resin 130 may be constituted by the element body 110. This makes it possible to increase the volume of the element body 110.

FIG. 10 is a schematic cross-sectional view for explaining a structure according to a second modification.

In the second modification illustrated in FIG. 10, the portion corresponding to the exposed part 131 of the insulating resin 130 is constituted by the element body 110, and portions of the mounting surface 111 of the element body 110 that are exposed through the openings 141 and 142 are recessed relative to the conductor layer L1 and the insulating resin 130 that are exposed on the mounting surface 111. That is, the portions of the mounting surface 111 of the element body 110 that are exposed through the openings 141 and 142 are positioned in the positive Y-direction relative to the conductor layer L1 and the insulating resin 130 that are exposed on the mounting surface 111. As a result, the conductor layer L1 and the insulating resin 130 that are exposed on the mounting surface 111 protrude relative to the portions of the mounting surface 111 that are exposed through the openings 141 and 142. Although only the cross section in which the conductor layer L1 appears is illustrated in FIG. 10, the same applies to the cross sections in which the conductor layers L2 to L6 appear. As exemplified by the second modification, the portions of the mounting surface 111 of the element body 110 that are exposed through the openings 141 and 142 may be recessed. Thus, even when the volume of the conductor constituting the terminal electrodes 121 and 122 is excessive, it is possible to suppress protrusion of the conductor constituting the terminal electrodes 121 and 122 from the surface of the coating film 140. Further, the contact area between the terminal electrodes 121 and 122 and the conductor layers L1 to L6 is enlarged.

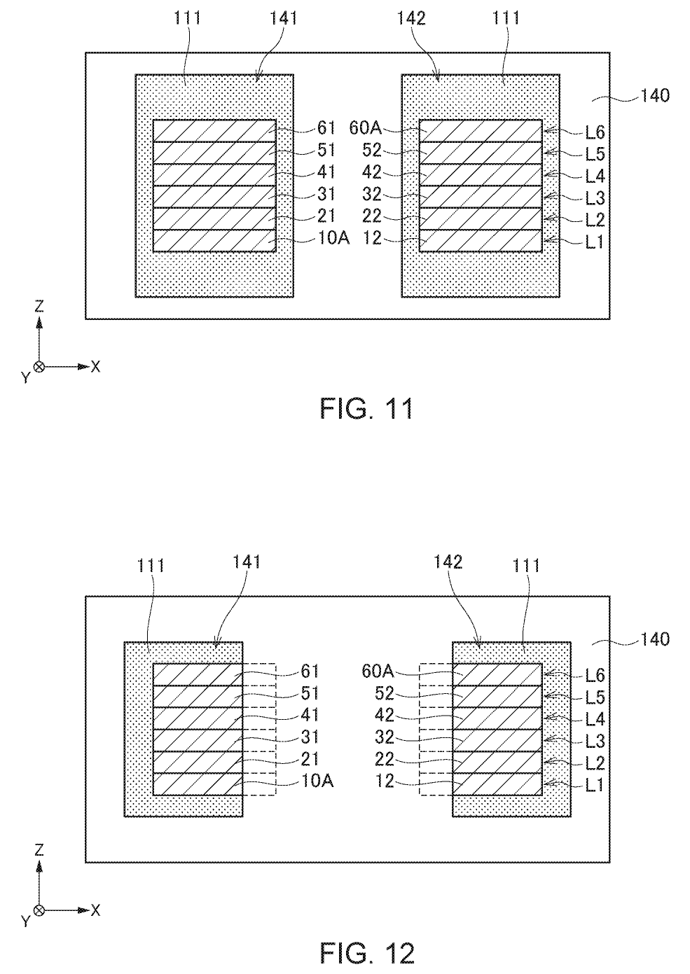

FIGS. 11 to 13 are schematic plan views for respectively explaining structures according to third to fifth modifications.

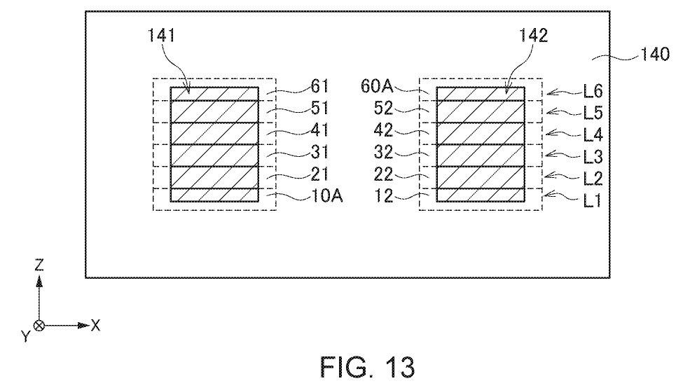

In the third modification illustrated in FIG. 11, the Z-direction dimensions of the openings 141 and 142 are smaller than that of the element body 110. In the fourth modification illustrated in FIG. 12, portions of the outer peripheral end 10A of the coil pattern and the terminal patterns 21, 31, 41, 51, and 61 do not overlap the opening 141 and are covered with the coating film 140, and portions of the terminal patterns 12, 22, 32, 42, and 52 and the outer peripheral end 60A of the coil pattern do not overlap the opening 142 and are covered with the coating film 140. In the fifth modification illustrated in FIG. 13, the size of the opening 141 is smaller than the total size of the outer peripheral end 10A of the coil pattern and the terminal patterns 21, 31, 41, 51, and 61, and the size of the opening 142 is smaller than the total size of the terminal patterns 12, 22, 32, 42, and 52 and the outer peripheral end 60A of the coil pattern. As exemplified by the third to fifth modifications, the openings 141 and 142 are not particularly limited in shape or size.

While the preferred embodiments of the present disclosure have been described, the present invention is not limited to the above embodiments, and various modifications may be made within the scope of the present invention, and all such modifications are included in the present invention.

For example, although the coil component 100 according to the above embodiment has a structure in which the six conductor layers L1 to L6 are embedded in the element body 110, the number of the conductor layers embedded in the magnetic element body is not limited to this.

The technology according to the present disclosure includes the following configuration examples, but not limited thereto.

A coil component according to an aspect of the present disclosure includes: an element body having a mounting surface; a coil part embedded in the element body and having one end and the other end exposed on the mounting surface; an insulating coating film covering the mounting surface and having a first opening through which the one end of the coil part is exposed and a second opening through which the other end of the coil part is exposed; a first terminal electrode provided in the first opening and contacting the one end of the coil part without overlapping the coating film; and a second terminal electrode provided in the second opening and contacting the other end of the coil part without overlapping the coating film. With this configuration, when the coil component is mounted on a circuit board using solder or the like, the mounting height can be reduced.

In the above coil component, the thicknesses of the first and second terminal electrodes may be smaller than the thickness of the coating film. This makes it possible to further reduce the mounting height.

In the above coil component, the element body may further have an upper surface located on the opposite side of the mounting surface, first and second side surfaces which are orthogonal to the mounting surface and the upper surface and located on mutually opposite sides, and third and fourth side surfaces, which are orthogonal to the mounting surface, the upper surface, and the first and second side surfaces, and which are located on mutually opposite sides, and the upper surface, the first side surface, the second side surface, the third side surface, and the fourth side surface may be fully covered with the coating film. This makes it possible to effectively protect the element body and to prevent detachment of filler particles contained in the element body.

In the above coil component, the mounting surface may be partially exposed through the first and second openings. This makes it possible to ensure sufficient areas for the first and second terminal electrodes. In this case, the one end and the other end of the coil part may protrude from portions of the mounting surface that are exposed through the first and second openings. This makes it possible to increase the contact area between the first terminal electrode and the one end of the coil part and the contact area between the second terminal electrode and the other end of the coil part.

The above coil component may further include an insulating resin located between the element body and the coil part, and the insulating resin may be partially exposed through the first and second openings. This makes it possible to enhance adhesion between the first and second terminal electrodes and the insulating resin.

What is claimed is:

1. A coil component comprising:
an element body having a mounting surface;
a coil part embedded in the element body and having one end and other end exposed on the mounting surface;
an insulating coating film covering the mounting surface, the insulating coating film having a first opening through which the one end of the coil part is exposed and a second opening through which the other end of the coil part is exposed;
a first terminal electrode provided in the first opening and contacting the one end of the coil part without overlapping the coating film; and
a second terminal electrode provided in the second opening and contacting the other end of the coil part without overlapping the coating film.

2. The coil component as claimed in claim 1, wherein thicknesses of the first and second terminal electrodes are smaller than a thickness of the coating film.

3. The coil component as claimed in claim 1,
wherein the element body further has:
an upper surface located on an opposite side of the mounting surface;
first and second side surfaces which are substantially orthogonal to the mounting surface and the upper surface and located on mutually opposite sides; and
third and fourth side surfaces, which are substantially orthogonal to the mounting surface, the upper surface, and the first and second side surfaces, and which are located on mutually opposite sides, and
wherein the upper surface, the first side surface, the second side surface, the third side surface, and the fourth side surface are fully covered with the coating film.

4. The coil component as claimed in claim 1, wherein the mounting surface is partially exposed through the first and second openings.

5. The coil component as claimed in claim 4, wherein the one end and the other end of the coil part protrude from portions of the mounting surface that are exposed through the first and second openings.

6. The coil component as claimed in claim 1, further comprising an insulating resin located between the element body and the coil part,
wherein the insulating resin is partially exposed through the first and second openings.
